(19) United States
(12) Patent Application Publication
(10) Pub. No.: US 2017/0083110 A1
(43) Pub. Date: Mar. 23, 2017

(54) FLEXIBLE DISPLAY INPUT DEVICE

(71) Applicant: International Business Machines Corporation, Armonk, NY (US)

(72) Inventors: James E. Bostick, Cedar Park, TX (US); John M. Ganci, JR., Cary, NC (US); Sarbajit K. Rakshit, Kolkata (IN); Craig M. Trim, Sylmar, CA (US)

(21) Appl. No.: 14/861,185

(22) Filed: Sep. 22, 2015

(51) Int. Cl. G06F 3/03; G02B 27/01; G06F 1/16

(52) U.S. Cl. CPC G06F 3/03; G06F 1/1652; G02B 27/0172; G02B 27/0149; G02B 2027/0178; G02B 2027/0138; G02B 2027/014

(57) ABSTRACT

A method for controlling a flexible display system comprises, receiving a signal indicating a deformation of a flexible display, processing the signal to identify the deformation of the flexible display, and initiating a software routine associated with the identified deformation of the flexible display.

### BACKGROUND

The present invention relates to flexible displays, and more specifically, to user inputs and flexible displays.

Flexible displays may include any number of display devices that are generally thin and flexible such that a user may bend the display with their hands. Such displays may be resilient such that the displays typically return to their original planar shape following the application of force to the displays. Other displays may be foldable such that the displays may be placed in the pocket of a user.

Wearable devices such as, glasses that augment reality may be worn by a user. Wearable glasses devices may dynamically present visual content or graphical content to a user. In typical operation such wearable devices often include a camera that sends data to a processor. The processor processes the data and determines how to present visual content to a user that is appropriate for the user's environment.

### SUMMARY

According to an embodiment of the present invention, a method for controlling a flexible display system comprises, receiving a signal indicating a deformation of a flexible display, processing the signal to identify the deformation of the flexible display, and initiating a software routine associated with the identified deformation of the flexible display.

According to another embodiment of the present invention, a method for controlling a flexible display system comprises receiving an image of a flexible display, processing the image to identify a deformation of the flexible display, initiating a software routine associated with the identified deformation of the flexible display.

A flexible display system comprising, a flexible display a processor communicatively connected to the flexible display, the processor operative to receive a signal indicating a deformation of a flexible display, process the signal to identify the deformation of the flexible display, and initiate a software routine associated with the identified deformation of the flexible display.

### BRIEF DESCRIPTION OF THE DRAWINGS

FIG. 1 illustrates a block diagram of an exemplary system.

FIG. 2 illustrates a front view of an exemplary embodiment of a flexible display.

FIG. 3 illustrates the flexible display bent into a concave position.

FIG. 4 illustrates the flexible display bent into a convex position.

FIG. 5 illustrates another exemplary operation of the flexible display.

FIG. 6A illustrates an exemplary embodiment of a list of content on a flexible display.

FIG. 6B illustrates an exemplary embodiment of a list of content on a flexible display.

FIG. 7 illustrates another exemplary embodiment of a display system

FIG. 8 illustrates a block diagram of an exemplary method of operation of the flexible display system of FIG. 1.

FIG. 9 illustrates a block diagram of another exemplary method of operation fo the flexible display system of FIG. 1.

### DETAILED DESCRIPTION

Flexible display devices may include any type of display that may be bent while displaying graphical information to a user. In an embodiment described below, a flexible display is bendable when a force is applied to the display, and has a resiliency such that the display may return to a substantially planar or unbent orientation when force is removed from the display. In an alternate embodiment, the display may be foldable similar to a sheet of plastic or paper. In other exemplary embodiments, the flexible display may be integrated in operation or in the system with a wearable device.

In operation, a flexible display may receive user input by, for example, touching or swiping, or by being bent, twisted, or folded, or in other ways deformed.

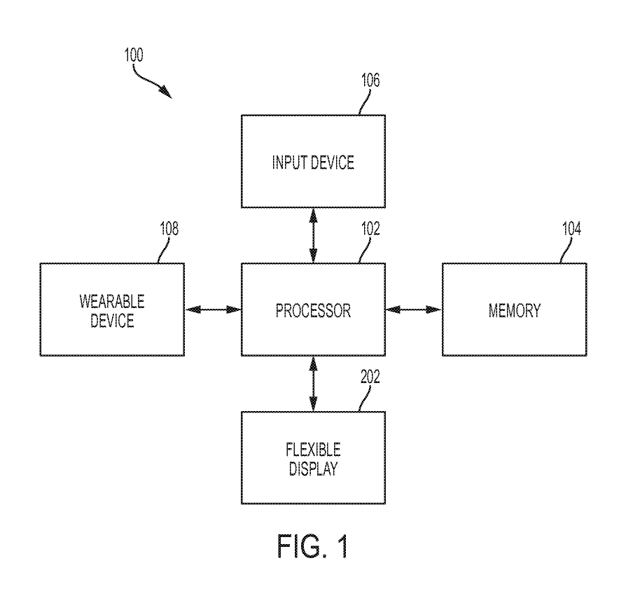

FIG. 1 illustrates a block diagram of an exemplary system 100. The system 100 includes a processor 102 that is communicatively connected to a memory device 104. The processor 102 may be communicatively connected to an input device 106 such as, for example, a button or microphone. The processor 102 is communicatively connected to a flexible display 202. In some exemplary embodiments, the processor 102 may also be communicatively connected to a wearable device 108 that may include, for example, glasses having a portion that is operative to present graphical images to a user. The wearable device 108 may also include a camera that is operative to send images to the processor 102.

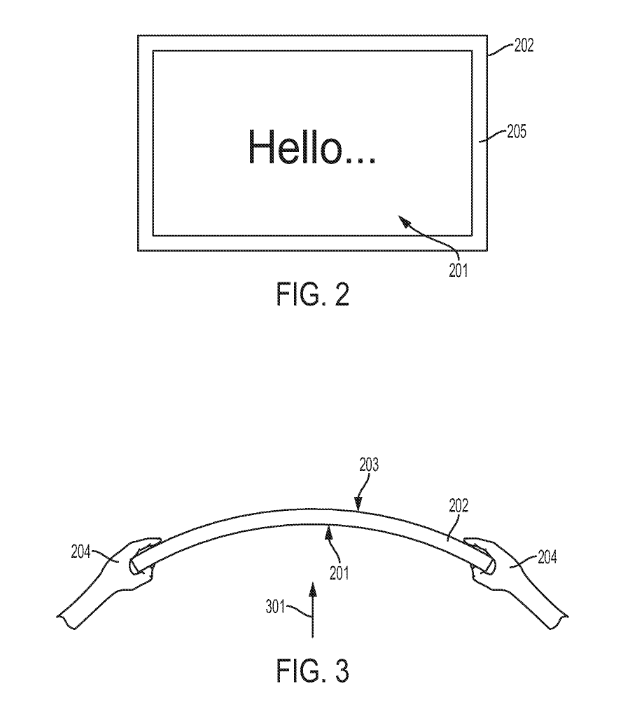

FIG. 2 illustrates a front view of an exemplary embodiment of a flexible display 202. The flexible display 202 has a display surface 201 that is operative to display graphical images to a user. The flexible display 202 may include an array of sensors 205 positioned, for example, around edges of the flexible display 202 that are operative to sense the shape of the flexible display 202. In the illustrated embodiment, the flexible display 202 is operative to send and receive signals to and from the processor 102 (of FIG. 1). The signals sent to the processor 102 may include data that includes a current shape of the flexible display 202.

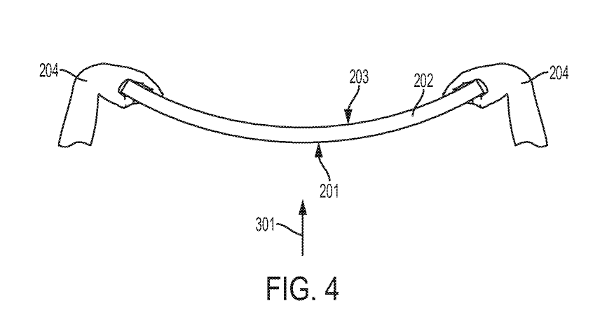

FIG. 3 illustrates the flexible display 202 while the flexible display 202 is being bent or deformed into a concave position. A rear surface 203 of the flexible display 202 is deformed into a convex shape. The arrow 301 indicates the direction the user 204 is facing relative to the flexible display 202.

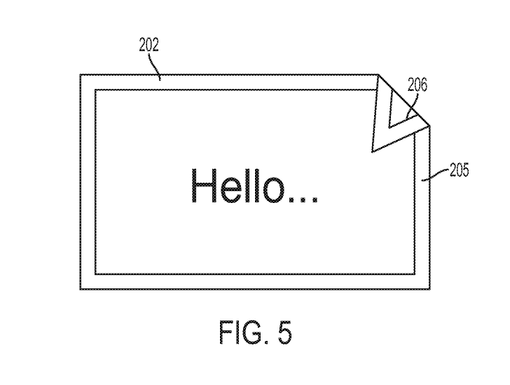

FIG. 4 illustrates the flexible display 202 while the flexible display 202 is being bent into a convex position. The arrow 302 indicates the direction the user is facing relative to the flexible display 202.

In operation, the sensors 205 of the flexible display 202 sense the position or curve of the display and send a signal to the processor 102 (of FIG. 1). In this regard, the processor 102 may determine an amount of curve, whether the curve is convex or concave, and a rate of the change in the curvature or deformation of the flexible display 202. Such signals may be used as inputs to the processor 102. For example, if the user 204 bends the display in a convex shape, the sensors 205 send a signal indicative of the convex shape to the processor 102, the processor 102 may process the signal as a user input and use the user input to control software or hardware functions controlled by the processor 102. Such user input may be used, for example, to initiate any suitable software or hardware routine. Examples of suitable software or hardware routines include, but are not limited to, turning the flexible display 202 on or off, changing the volume of audio output by the system 100, sharing a website address with other users, sending or receiving messages to other users, web browser functions, operating system functions, and the like.

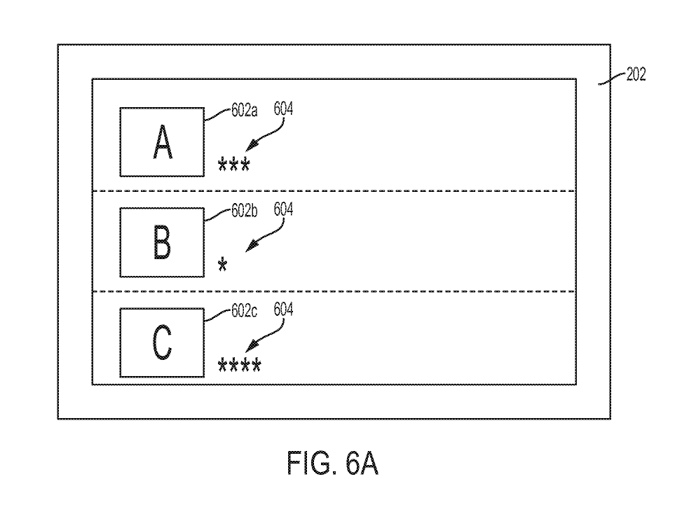

FIG. 5 illustrates another exemplary operation of the flexible display 202. In this regard, a corner 206 of the flexible display 202 has been bent by the user 204 (of FIG. 4) in a similar manner as one would bend a corner of a sheet of paper. Such a deformation of the flexible display 202 may be sensed by the sensors 205 such that the processor 102 (of FIG. 1) receives a signal that indicates that the corner 206 has been bent by the user 204. The illustrated embodiment of FIG. 5 shows one deformed corner 206, however any corner or edge of the flexible display 202 may be deformed in a similar manner alone or in combination with the corner 206. Thus, the bending of the corner 206 may be sensed by the sensors 205 and a corresponding signal may be processed by the processor 102 as a discrete user input, which may initiate any suitable software or hardware routine. Examples of suitable software or hardware routines include, but are not limited to, turning the flexible display 202 on or off, changing the volume of audio output by the system 100, sharing a website address with other users, sending or receiving messages to other users, web browser functions, operating system functions, and the like.

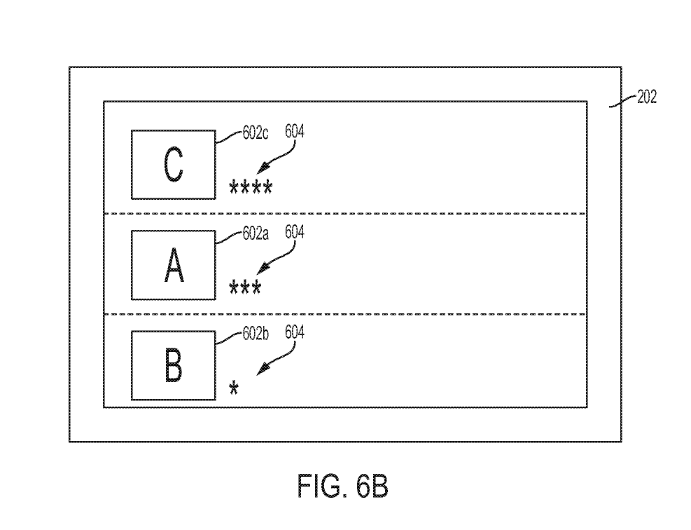

FIG. 6A illustrates an exemplary embodiment of the display 202. The display 202 is presenting a list of content 600. The list of content 600 of the illustrated embodiment includes three video files 602a, 602b and 602c having metadata 604 that includes rankings that are indicated by star icons, where a greater number of star icons indicates user rankings of each video file 602.

FIG. 6B illustrates the display 200 where the list of content 600 has been sorted by the metadata 604 such that the video files are ordered by the number of star icons associate with the video file 602. In the illustrated embodiment, the list of content 600 is sorted following a user input where the user bends the flexible display 202 into a concave shape like the shape shown in FIG. 3.

The illustrated embodiments of FIGS. 6A and 6B are mere examples of sorting a list of content 600 by metadata associated with items in the list of content 600. In this regard, any of the user inputs or flexible display 202 deformations that are sensed by the sensors 205 and received by the processor 102 may be used to sort the list of content 600 in any particular order relevant to the metadata 604. The metadata 604 may include, for example, rankings, popularity, recommendations, or any other type of sortable metatada.

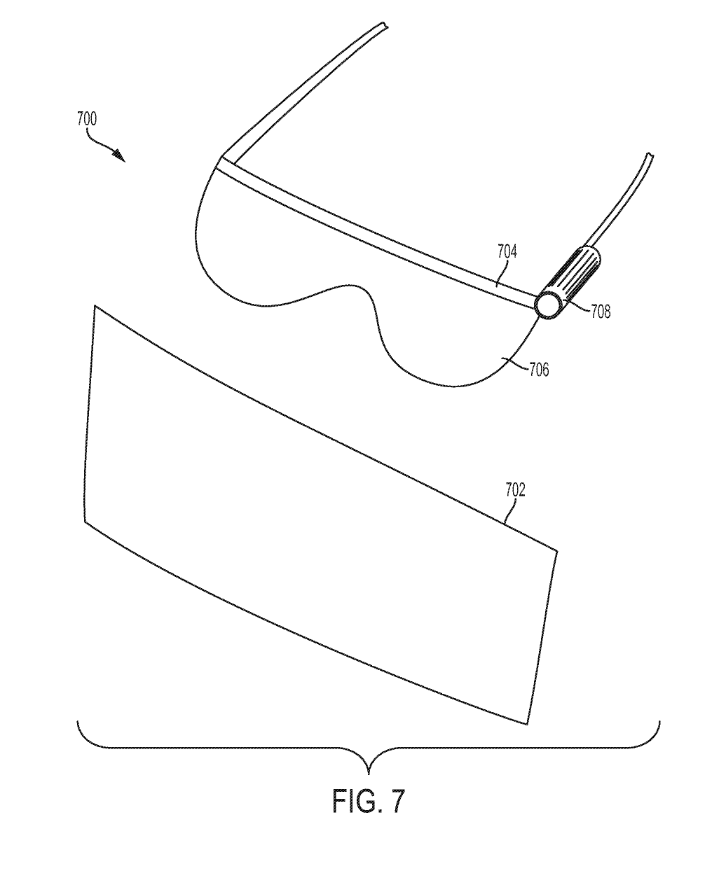

FIG. 7 illustrates an exemplary embodiment of a display system 700 that includes a wearable device 702 that includes a display area 706 and a camera 708. The wearable device 704 is operative to send video data to the processor 102 (of FIG. 1) from the camera 708 and to display graphics or other visual data to the user via the display area 706. The display area 706 is substantially transparent such that graphics displayed in the display area 706 are visible to the user while the user may also see the surroundings through the display area 706. A flexible display 702 is shown within the view of the user. The flexible display 702 may be similar to the flexible display 202 (of FIG. 2) described above, or may be a simple flexible sheet or screen. In this regard, the flexible display 702 may be used as a screen such that the wearable device 702 presents graphics that appear to the user to be shown on the screen. Such an illusion is controlled by the wearable device 704 and the processor 102 by receiving video data from the camera 708 and processing the data to determine a position and orientation of the flexible display 702.

In operation, when a user bends the flexible display 702 in a manner similar to the deformation of the flexible display 202 described above, the wearable device 702 may, via the camera 702 or sensors in the flexible display 702 determine the position or deformation position or rate of deformation of the flexible display 702. Upon determining that the flexible display 702 has been deformed, the wearable device 704 may associate the deformation with a user input, which may initiate any suitable hardware or software routines as described above.

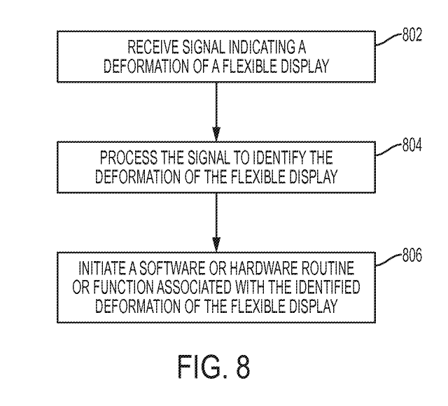

FIG. 8 illustrates a block diagram of an exemplary method of operation of the system 100 (of FIG. 1). In block 802, the processor 102 receives a signal that indicates a deformation of the flexible display 202 (of FIG. 2). In block 804, the processor 102 processes the signal to identify or determine the deformation of the flexible display 202. For example, the signal may be processed to identify that the flexible display 202 has been deformed into a convex or concave shape relative to the user, that a corner of the flexible display 202 has been bent, and a rate of change of the deformation of the flexible display 202.

In block 806, the processor 102, initiates a hardware function or a software routine that is associated with the identified deformation or rate of change of the deformation of the flexible display 202. Examples of suitable software or hardware routines include, but are not limited to, turning the flexible display 202 on or off, changing the volume of audio output by the system 100, sharing a website address with other users, sending or receiving messages to other users, web browser functions, operating system functions, and the like.

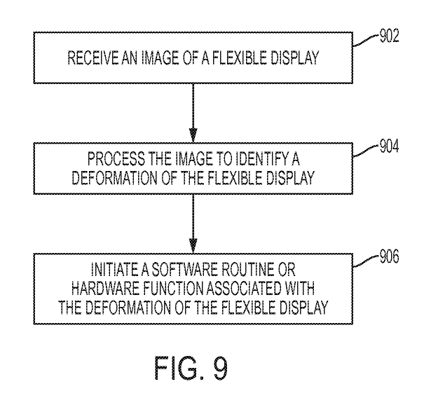

FIG. 9 illustrates a block diagram of an exemplary method for controlling the system 700 (of FIG. 7). In block 902, an image of a flexible display 702 is received by the processor 102 (of FIG. 1). In block 904 the processor 102 processes the image to identify a deformation of the flexible display 702. The processor 102 may receive any number of images, sets of images, or video that may be used to determine how the flexible display 702 has been deformed including determining a rate of change in the deformation of the flexible display 702. In block 906, the processor 102 initiates a software routine or hardware function associated with the identified deformation of the flexible display.

The systems and methods described above provide a method for a user to provide user inputs to a system by bending a flexible display. The user inputs may be received by a processor and used to initiate any suitable hardware or software routine.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for controlling a flexible display system, the method comprising:
receiving a signal indicating a deformation of a flexible display;
processing the signal to identify the deformation of the flexible display; and
initiating a software routine associated with the identified deformation of the flexible display.

2. The method of claim 1, wherein the deformation of the flexible display includes bending the flexible display into a convex shape.

3. The method of claim 1, wherein the deformation of the flexible display includes bending the flexible display into a concave shape.

4. The method of claim 1, wherein the deformation of the flexible display includes bending a corner of the flexible display.

5. The method of claim 1, wherein the signal indicating the deformation of the flexible display is received from sensors in the flexible display.

6. The method of claim 1, wherein the software routine includes sorting a list of content presented on the flexible display by metadata associated with the content in the list of content.

7. The method of claim 6, wherein the metadata includes rankings associated with the content in the list of content.

8. The method of claim 1, wherein the processing the signal to identify the deformation of the flexible display includes identifying a rate of change in the deformation of the flexible display.

9. A method for controlling a flexible display system, the method comprising:
receiving an image of a flexible display;
processing the image to identify a deformation of the flexible display;
initiating a software routine associated with the identified deformation of the flexible display.

10. The method of claim 9, wherein the deformation of the flexible display includes bending the flexible display into a convex shape.

11. The method of claim 9, wherein the deformation of the flexible display includes bending the flexible display into a concave shape.

12. The method of claim 9, wherein the deformation of the flexible display includes bending a corner of the flexible display.

13. The method of claim 9, wherein the image is received from a camera of a user wearable device.

14. The method of claim 9, wherein the software routine includes sorting a list of content presented on the flexible display by metadata associated with the content in the list of content.

15. The method of claim 14, wherein the metadata includes rankings associated with the content in the list of content.

16. The method of claim 9, wherein the processing the image to identify the deformation of the flexible display includes identifying a rate of change in the deformation of the flexible display.

17. A flexible display system comprising:
a flexible display;
a processor communicatively connected to the flexible display, the processor operative to:
receive a signal indicating a deformation of a flexible display;
process the signal to identify the deformation of the flexible display; and
initiate a software routine associated with the identified deformation of the flexible display.

18. The system of claim 17, wherein the deformation of the flexible display includes bending the flexible display into a convex shape.

19. The system of claim 17, wherein the deformation of the flexible display includes bending the flexible display into a concave shape.

20. The system of claim 17, wherein the deformation of the flexible display includes bending a corner of the flexible display.
